(19) United States
(12) Patent Application Publication
(10) Pub. No.: US 2008/0272329 A1
(43) Pub. Date: Nov. 6, 2008

(54) Piezoelectric Ceramic Composition

(75) Inventors: Atsushi Ito, Gifu (JP); Yoshiya Matsuno, Gifu (JP); Haruhide Shikano, Gifu (JP); Takahiko Ido, Gifu (JP); Takuo Matsuyama, Osaka (JP); Shigeo Fukuyasu, Osaka (JP); Masakazu Ueno, Osaka (JP)

Correspondence Address: YOUNG & THOMPSON, 209 Madison Street, Suite 500, ALEXANDRIA, VA, 22314, US

(73) Assignees: IBIDEN CO., LTD., GIFU (JP); DAI NIPPON TORYO CO.,LTD, OSAKA (JP)

(21) Appl. No.: 11/884,930

(22) PCT Filed: Feb. 22, 2006
(86) PCT No.: PCT/JP2006/303181

§ 371 Date: Aug. 23, 2007

(30) Foreign Application Priority Data
Mar. 1, 2005 (JP) 2005-055270

(51) Int. Cl. C04B 35/462

(52) U.S. Cl. 252/62.9 PZ

(57) ABSTRACT

The present invention provides a piezoelectric ceramic composition, for producing piezoelectric elements exhibiting high piezoelectric strain constant d₃₃ and high Curie temperature Tc, which composition includes a perovskite PbZrO₃ (a), a perovskite PbTiO₃ (b), SrO (c), Nb₂O₅ (d) and ZnO (e), and relative amounts of the components (a), (b), (c) (d) and (e) satisfy the general formula:

Pb(ZrₐTi₁₋ₐ)O₃+bSrO+cNbO_{2.5}+dZnO

wherein 0.51≦a≦0.54; 1.1×10⁻²≦b≦6.0×10⁻²; 0.9×10⁻²≦c≦4.25×10⁻²; 0.1×10⁻²≦d≦1.25×10⁻²; and 2.9≦c/d≦15.0.

### TECHNICAL FIELD

The present invention relates to a piezoelectric ceramic composition and, more particularly, to a piezoelectric ceramic composition exhibiting high piezoelectric strain constant d₃₃ and high Curie temperature Tc.

### BACKGROUND ART

Hitherto, piezoelectric devices such as ultrasonic vibrators, sound generators, actuators, and sensors have employed piezoelectric elements produced from a piezoelectric ceramic composition. In such devices, there is demand for improving piezoelectric characteristics of the piezoelectric ceramic composition so as to reduce dimensions of piezoelectric devices and enhance energy conversion efficiency.

As used herein, the term “piezoelectric characteristics” refers to generation of strain through application of mechanical stress to an piezoelectric element, resulting in electric polarization, or generation of strain proportional to electric polarization through application of an electric field to a piezoelectric element. In order to evaluate piezoelectric characteristics, piezoelectric strain constant d₃₃ or a similar parameter, which is a material constant of piezoelectric elements and serves as an index for piezoelectric effect, is determined. For producing a piezoelectric device, for example, an ultrasonic vibrator, a piezoelectric ceramic composition exhibiting high piezoelectric strain constant d₃₃ is advantageously employed, since electromechanical energy conversion efficiency is enhanced with an increase in piezoelectric strain constant d₃₃.

In recent years, piezoelectric elements are not only employed in apparatuses for use at room temperature, but also in apparatuses for use under severe (high-temperature) conditions. Thus, reliability of piezoelectric elements under high-temperature conditions is demanded. In order to evaluate high-temperature characteristics, Curie temperature Tc, which is another material constant of piezoelectric elements and serves as an index for heat-resistant effect, is employed. The higher the Curie temperature Tc, the more effective the prevention of depolarization under high-temperature conditions. Therefore, a piezoelectric ceramic composition exhibiting high Curie temperature Tc finds uses which must exhibit stability in characteristics under high-temperature conditions.

As mentioned above, in order to reduce dimensions of piezoelectric devices and enhance energy conversion efficiency, the piezoelectric strain constant d₃₃ of piezoelectric elements must be increased, whereas Curie temperature Tc of piezoelectric elements must be elevated in order to improve high-temperature characteristics and stability in characteristics under high-temperature conditions. Therefore, in recent years, there has been a demand for a piezoelectric ceramic composition for constituting piezoelectric elements, which composition exhibits satisfactory piezoelectric strain constant d₃₃ and Curie temperature Tc, and a variety of piezoelectric ceramic compositions have been proposed (see, for example, Patent Documents 1 and 2).

Patent Document 1: Japanese Patent Application Laid-Open (kokai) No. 2000-327418
Patent Document 2: Japanese Patent Application Laid-Open (kokai) No. 2001-097774

### DISCLOSURE OF THE INVENTION

### Problems to be Solved by the Invention

The present invention has been completed considering the fact of the aforementioned prior art. Thus, an object of the present invention is to provide a piezoelectric ceramic composition for constituting piezoelectric elements, which composition exhibits high piezoelectric strain constant d₃₃ and high Curie temperature Tc.

### Means for Solving the Problems

The present inventors have conducted extensive studies in order to attain the aforementioned object, and have found that incorporating specific amounts of SrO, Nb₂O₅, and ZnO into a PbZrO₃-PbTiO₃ composition enables production of a piezoelectric ceramic composition for constituting piezoelectric elements, which composition exhibits high piezoelectric strain constant d₃₃ and high Curie temperature Tc. The present invention has been accomplished on the basis of this finding.

Accordingly, the piezoelectric ceramic composition of the present invention comprises a perovskite PbZrO₃ (a), a perovskite PbTiO₃ (b), SrO (c), Nb₂O₅ (d) and ZnO (e), and relative amounts of the components (a), (b), (c), (d) and (e) satisfy the general formula:

Pb(ZrₐTi₁₋ₐ)O₃+bSrO+cNbO_{2.5}+dZnO

wherein 0.51≦a≦0.54; 1.1×10⁻²≦b≦6.0×10⁻²; 0.9×10⁻²≦c≦4.25×10⁻²; 0.1×10⁻²≦d≦1.25×10⁻²; and 2.9≦c/d≦15.0.

### EFFECTS OF THE INVENTION

Since the piezoelectric ceramic composition of the present invention has specific compositonal proportions, the piezoelectric strain constant d₃₃ and Curie temperature Tc of the composition are high. Therefore, the composition is suitable for producing piezoelectric elements such as ultrasonic vibrators, sound generators, and actuators.

### BEST MODES FOR CARRYING OUT THE INVENTION

The piezoelectric ceramic composition of the present invention will next be described in more detail.

As understood from the data obtained in the Examples and Comparative Examples shown hereinbelow, in the piezoelectric ceramic composition of the present invention, relative amounts of the components (a), (b), (c), (d) and (e) satisfy the general formula:

Pb(ZrₐTi₁₋ₐ)O₃+bSrO+cNbO_{2.5}+dZnO

wherein, preferably 0.51≦a≦0.54; 1.1×10⁻²≦b≦6.0×10⁻²; 0.9×10⁻²≦c≦4.25×10⁻²; 0.1×10⁻²≦d≦1.25×10⁻²; and 2.9≦c/d≦15.0, and more preferably, 0.52≦a≦0.54; 1.2×10⁻²≦b≦5.0×10⁻²; 1.0×10⁻²≦c≦4.0×10⁻²; 0.2×10⁻²≦d≦1.0×10⁻²; and 3.0≦c/d≦13.0.

Piezoelectric elements produced from the piezoelectric ceramic composition of the present invention, satisfying the aforementioned conditions, exhibit desired high piezoelectric strain constant d₃₃ and Curie temperature Tc; e.g., a piezoelectric strain constant d₃₃ higher than 400 pC/N and a Curie temperature Tc higher than 300° C.

However, when in the general formula:

Pb(ZrₐTi₁₋ₐ)O₃+bSrO+cNbO_{2.5}+dZnO

“a” is smaller than 0.51 or greater than 0.54, piezoelectric elements produced from such a piezoelectric ceramic composition tend to exhibit low piezoelectric strain constant d₃₃, which is not preferred. Thus, in the piezoelectric ceramic composition of the present invention, “a” preferably satisfies 0.51≦a≦0.54, and more preferably 0.52≦a≦0.54.

When “b” is smaller than 1.1×10⁻², piezoelectric elements produced from such a piezoelectric ceramic composition tend to exhibit low piezoelectric strain constant d₃₃, which is not preferred. When “b” is greater than 6.0×10⁻², piezoelectric elements produced from such a piezoelectric ceramic composition tend to exhibit low Curie temperature Tc, which is not preferred. Thus, in the piezoelectric ceramic composition of the present invention, “b” preferably satisfies 1.1×10⁻²≦b≦6.0×10⁻², and more preferably, 1.2×10⁻²≦b≦5.0×10⁻².

When “c” is smaller than 0.9×10⁻², piezoelectric elements produced from such a piezoelectric ceramic composition tend to exhibit low piezoelectric strain constant d₃₃, which is not preferred. When “c” is greater than 4.25×10⁻², piezoelectric elements produced from such a piezoelectric ceramic composition tend to exhibit low Curie temperature Tc, which is not preferred. Thus, in the piezoelectric ceramic composition of the present invention, “c” preferably satisfies 0.9×10⁻²≦c≦4.25×10⁻², and more preferably, 1.0×10⁻²≦c≦4.0×10⁻².

When “d” is smaller than 0.1×10⁻², piezoelectric elements produced from such a piezoelectric ceramic composition tend to exhibit low piezoelectric strain constant d₃₃, which is not preferred. When “d” is greater than 1.25×10⁻², piezoelectric elements produced from such a piezoelectric ceramic composition tend to exhibit low Curie temperature Tc, which is not preferred. Thus, in the piezoelectric ceramic composition of the present invention, “d” preferably satisfies 0.1×10⁻²≦d≦1.25×10⁻², and more preferably, 0.2×10⁻²≦d≦1.0×10−−2.

Even when the conditions 0.9×10⁻²≦c≦4.25×10⁻² and 0.1×10⁻²≦d≦1.25×10⁻² are satisfied, in the case where the c/d value is smaller than 2.9 or greater than 15.0, piezoelectric elements produced from such a piezoelectric ceramic composition tend to exhibit low piezoelectric strain constant d₃₃, which is not preferred. Thus, in the piezoelectric ceramic composition of the present invention, “c/d” preferably satisfies 2.9≦c/d≦15.0, and more preferably, 3.0≦c/d≦13.0.

The piezoelectric ceramic composition of the present invention may be produced through any of a variety of methods. For example, the following production method may be employed.

First, a Pb component, a Zr component, a Ti component, an Sr component, a Zn component, and an Nb component of a starting material, each in powder form, are weighed to provide required amounts thereof, and the starting material powders are mixed and pulverized by means of a pulverizer such as a ball mill. Mixing and pulverization are preferably performed in a wet process in the presence of water in order to attain uniformity in the process. When the wet process is employed, water is incorporated into the mixture in an amount of 50 to 75% based on the total mass, preferably 60 to 70%. No particular limitation is imposed on the time for mixing and pulverization, so long as uniform mixing and pulverization can be satisfactorily attained. For example, the process is performed for 5 to 30 hours, preferably 10 to 20 hours. After drying, the thus-formed powder mixture is generally calcinated in an oxidizing atmosphere such as the atmosphere at 700 to 1,000° C., preferably at 800 to 900° C. for 1 to 7 hours, preferably for 2 to 5 hours.

No particular limitation is imposed on the type of the Pb component employed in the aforementioned production method so long as the Pb component can form lead oxide through firing, and a variety of Pb components may be employed. Examples of the Pb component include lead oxides such as Pb₃O₄ (red lead) and PbO.

No particular limitation is imposed on the type of the Zr component employed in the aforementioned production method so long as the Zr component can form zirconium oxide through firing, and a variety of zirconium components may be employed. Examples of the Zr component include zirconium oxides such as zirconium dioxide, and zirconium hydroxide.

No particular limitation is imposed on the type of the Ti component employed in the aforementioned production method so long as the Ti component can form titanium oxide through firing, and a variety of titanium components may be employed. Examples of the Ti component include titanium oxides such as titanium dioxide, and titanium hydroxide.

No particular limitation is imposed on the type of the Sr component employed in the aforementioned production method so long as the Sr component can form strontium oxide through firing, and a variety of strontium components may be employed. Examples of the Sr component include strontium oxide and strontium carbonate.

No particular limitation is imposed on the type of the Nb component employed in the aforementioned production method so long as the Nb component can form niobium oxide through firing, and a variety of niobium components may be employed. Examples of the Nb component include niobium oxides such as diniobium pentoxide.

No particular limitation is imposed on the type of the Zn component employed in the aforementioned production method so long as the Zn component can form zinc oxide through firing, and a variety of zinc components may be employed. Examples of the Zn component include zinc oxide, zinc hydroxide, zinc nitrate, and zinc carbonate. Of these, zinc oxide is preferably employed.

These metallic components are formulated in such relative amounts, atomic proportion, of Pb component, Zr component, Ti component, Sr component, Nb component and Zn component that, the general formula:

Pb(ZrₐTi₁₋ₐ)O₃+bSrO+cNbO_{2.5}+dZnO

satisfies the following conditions: 0.51≦a≦0.54; 1.1×10⁻²≦b≦6.0×10⁻²; 0.9×10⁻²≦c≦4.25×10⁻²; 0.1×10⁻²≦d≦1.25×10⁻²; and 2.9≦c/d≦15.0, and preferably the following conditions: 0.52≦a≦0.54; 1.2×10⁻²≦b≦5.0×10⁻²; 1.0×10⁻²≦c≦4.0×10⁻²; 0.2×10⁻²≦d≦1.0×10⁻²; and 3.0≦c/d≦13.0.

Under the aforementioned conditions, the Pb component, Zr component, Ti component, Sr component, Nb component and Zn component are mixed and pulverized, and the powder mixture is calcinated, whereby a calcination product containing a perovskite PbZrO₃ (a), a perovskite PbTiO₃ (b), SrO (c), Nb₂O₅ (d) and ZnO (e) is yielded.

The thus-yielded calcination product was pulverized by means of a pulverizer such as a ball mill so as to form a powder mixture generally having a mean particle size of 0.1 to 2.0 μm, preferably 0.1 to 1.0 μm. The pulverization is preferably performed in a wet process in the presence of water in order to attain uniformity in the process. The amount of water employed in pulverization is preferably 50 to 75% based on the total mass, and more preferably 60 to 70%. No particular limitation is imposed on the pulverization time so long as the time is enough to attain sufficiently uniform pulverization. For example, the pulverization time is 5 to 30 hours, preferably 10 to 20 hours. After pulverization, the formed powder is dried.

To the thus-pulverized product, for example, a binder resin such as polyvinyl alcohol is added, and the formed mixture is press-molded to a bulk form, a sheet form, etc. The molded product is fired, to thereby produce a piezoelectric element from the piezoelectric ceramic composition of the present invention. Alternatively, a piezoelectric element may also be formed from the piezoelectric ceramic composition of the present invention through stacking molded sheets of the powder, attaching an electrode between the stacked layers, and firing.

By virtue of the compositional characteristics, the piezoelectric ceramic composition of the present invention can be produced through firing at 1,050 to 1,250° C., and preferably at 1,100 to 1,200° C. for 1 to 8 hours, preferably for 2 to 5 hours.

### EXAMPLES

The present invention will next be described in more detail.

### Examples 1 to 17 and Comparative Examples 1 to 10

Starting powders of PbO, TiO₂, ZrO₂, SrO, Nb₂O5 and ZnO were weighed so that the compositional proportions shown in Table 1 were realized. Each of “a,” “b,” “c,” and “d” in Table 1 represents a metal atomic ratio in the following compositional formula:

Pb(ZrₐTi₁₋ₐ)O₃+bSrO+cNbO_{2.5}+dZnO.

In each of the Examples and Comparative Examples, these starting powders were placed in a ball mill, and water was added to the mixture so that the water content was adjusted to 65% based on the total mass. The powder mixture and water were mixed for 20 hours in a wet process. After drying, the dried product was calcinated in a firing pot at 850° C. The calcinated powder was pulverized for 20 hours by means of a ball mill, followed by drying.

A binder (polyvinyl alcohol) was added to the thus-pulverized powder with mixing, and the mixture was press-molded at 100 MPa by means of a press machine. The formed compact was fired at 1,200° C. for two hours, to thereby yield a sintered compact.

Subsequently, electrodes were attached to the sintered compact through baking, and the resultant product was polarized at 4 kV/mm. Piezoelectric strain constant d₃₃ (pC/N) and Curie temperature Tc (° C.) of the thus-produced piezoelectric ceramic composition were determined. The results are shown in Table 1.

With an aim to clarify preferred compositional proportions of starting powders of PbO, TiO₂, ZrO₂, SrO, Nb₂O₅ and ZnO on the basis of the Examples and Comparative Examples, in Table 1, data of metal atomic ratio parameters of “a,” “b,” “c,” “d,” and “c/d”, in

Pb(ZrₐTi₁₋ₐ)O₃+bSrO+cNbO_{2.5}+dZnO

are shown, with the data of Example 3 and those of Example 13 being given twice in two separate rows, for the sake of easy understanding of preferred ranges of the parameters.

TABLE 1

| | a | b × 10² | c × 10² | d × 10² | c/d | d₃₃ | Tc |
|---|---|---|---|---|---|---|---|
| Comp. EX. 1 | 0.49 | 2.0 | 1.50 | 0.5 | 3.0 | 380 | 345 |
| Ex. 1 | 0.51 | 2.0 | 1.50 | 0.5 | 3.0 | 400 | 345 |
| Ex. 2 | 0.52 | 2.0 | 1.50 | 0.5 | 3.0 | 410 | 345 |
| Ex. 3 | 0.53 | 2.0 | 1.50 | 0.5 | 3.0 | 430 | 340 |
| Ex. 4 | 0.54 | 2.0 | 1.50 | 0.5 | 3.0 | 400 | 340 |
| Comp. EX. 2 | 0.55 | 2.0 | 1.50 | 0.5 | 3.0 | 360 | 335 |
| Comp. EX. 3 | 0.53 | 1.0 | 1.50 | 0.5 | 3.0 | 380 | 350 |
| Ex. 5 | 0.53 | 1.1 | 1.50 | 0.5 | 3.0 | 400 | 345 |
| Ex. 6 | 0.53 | 1.2 | 1.50 | 0.5 | 3.0 | 410 | 345 |
| Ex. 3 | 0.53 | 2.0 | 1.50 | 0.5 | 3.0 | 430 | 340 |
| Ex. 7 | 0.53 | 5.0 | 1.50 | 0.5 | 3.0 | 430 | 310 |
| Ex. 8 | 0.53 | 6.0 | 1.50 | 0.5 | 3.0 | 430 | 300 |
| Comp. EX. 4 | 0.53 | 7.0 | 1.50 | 0.5 | 3.0 | 430 | 290 |
| Comp. EX. 5 | 0.53 | 2.0 | 0.75 | 0.25 | 3.0 | 370 | 355 |
| Ex. 9 | 0.53 | 2.0 | 0.90 | 0.25 | 3.6 | 400 | 350 |
| Ex. 10 | 0.53 | 2.0 | 1.50 | 0.25 | 6.0 | 420 | 345 |
| Ex. 11 | 0.53 | 2.0 | 3.75 | 0.25 | 15.0 | 410 | 330 |
| Ex. 12 | 0.53 | 2.0 | 4.25 | 0.30 | 14.2 | 410 | 300 |
| Comp. EX. 6 | 0.53 | 2.0 | 4.50 | 0.30 | 15.0 | 410 | 295 |
| Comp. EX. 7 | 0.53 | 2.0 | 1.20 | 0.08 | 15.0 | 370 | 360 |
| Ex. 13 | 0.53 | 2.0 | 1.50 | 0.10 | 15.0 | 400 | 345 |
| Ex. 14 | 0.53 | 2.0 | 3.75 | 0.50 | 7.5 | 420 | 310 |
| Ex. 15 | 0.53 | 2.0 | 3.75 | 1.25 | 3.0 | 430 | 300 |
| Comp. EX. 8 | 0.53 | 2.0 | 3.75 | 1.30 | 2.9 | 400 | 295 |
| Comp. EX. 9 | 0.53 | 2.0 | 1.50 | 0.60 | 2.5 | 300 | 345 |
| Ex. 16 | 0.53 | 2.0 | 1.50 | 0.52 | 2.9 | 400 | 345 |
| Ex. 17 | 0.53 | 2.0 | 1.50 | 0.30 | 5.0 | 420 | 345 |
| Ex. 13 | 0.53 | 2.0 | 1.50 | 0.10 | 15.0 | 400 | 345 |
| Comp. EX. 10 | 0.53 | 2.0 | 1.60 | 0.10 | 16.0 | 390 | 340 |

As is clear from the date shown in Table 1, all the piezoelectric elements produced from piezoelectric ceramic compositions of Examples 1 to 17, falling within the scope of the invention, exhibit high piezoelectric strain constant d₃₃ and high Curie temperature Tc.

However, as is clean from the data of Comparative Example 1, when “a” is less than 0.51, piezoelectric strain Example 1, when “a” is less than 0.51, piezoelectric strain constant d₃₃ disadvantageously decreases. As is clean from the data of Comparative Example 2, when “a” is greater than 0.54, piezoelectric strain constant d₃₃ also disadvantageously decreases.

As is clean from the data of Comparative Example 3, when “b” is less than 1.1×10⁻², piezoelectric strain constant d₃₃ disadvantageously decreases. As is clean from the data of Comparative Example 4, when “b” is greater than 6.0×10⁻², Curie temperature Tc is disadvantageously lowered.

As is clean from the data of Comparative Example 5, when “c” is less than 0.9×10⁻², piezoelectric strain constant d₃₃ disadvantageously decreases. As is clean from the data of Comparative Example 6, when “c” is greater than 4.25×10⁻², Curie temperature Tc is disadvantageously lowered.

As is clean from the data of Comparative Example 7, when “d” is less than 0.1×10⁻², piezoelectric strain constant d₃₃ disadvantageously decreases. As is clean from the data of Comparative Example 8, when “d” is greater than 1.25×10⁻², Curie temperature Tc is disadvantageously lowered.

Furthermore, as is clean from the data of Comparative Example 9, even when “c” satisfies the condition: 0.9×10⁻²≦c≦4.25×10⁻² and “d” satisfies the condition: 0.1×10⁻²≦d≦1.25×10⁻², in the case where the c/d value is smaller than 2.9, piezoelectric strain constant d₃₃ disadvantageously decreases. Furthermore, as is clean from the data of Comparative Example 10, even when “c” satisfies the condition: 0.9×10⁻²≦c≦4.25×10⁻² and “d” satisfies the condition: 0.1×10⁻²≦d≦1.25×10⁻², in the case where the c/d value is greater than 15.0, piezoelectric strain constant d₃₃ disadvantageously decreases.

1. A piezoelectric ceramic composition characterized in that the composition comprises a perovskite PbZrO₃ (a), a perovskite PbTiO₃ (b), SrO (c), Nb₂O₅ (d) and ZnO (e), and relative amounts of the components (a), (b), (c), (d) and (e) satisfy the general formula:
Pb(ZrₐTi₁₋ₐ)O₃+bSrO+cNbO_{2.5}+dZnO
wherein 0.51≦a≦0.54; 1.1×10⁻²≦b≦6.0×10⁻²; 0.9×10⁻²≦c≦4.25×10⁻²; 0.1×10⁻²≦d≦1.25×10⁻²; and 2.9≦c/d≦15.0.

2. A piezoelectric ceramic composition as described in claim 1, wherein relative amounts of the components (a), (b), (c), (d) and (e) satisfy the general formula:
Pb(ZrₐTi₁₋ₐ)O₃+bSrO+cNbO_{2.5}+dZnO
wherein 0.52≦a≦0.54; 1.2×10⁻²≦b≦5.0×10⁻²; 1.0×10⁻²≦c≦4.0×10⁻²; 0.2×10⁻²≦d≦1.0×10⁻²; and 3.0≦c/d≦13.0.
